(19) United States
(12) Patent Application Publication
(10) Pub. No.: US 2014/0083702 A1
(43) Pub. Date: Mar. 27, 2014

(54) IN SITU POLYMERIZATION FOR COMPLETIONS SEALING OR REPAIR

(71) Applicant: Schlumberger Technology Corporation, Sugar Land, TX (US)

(72) Inventors: MATTHEW GODFREY, WATERTOWN, MA (US); AGATHE ROBISSON, CAMBRIDGE, MA (US); ROMAN KATS, BROOKLINE, MA (US); JOHN DAVID ROWATT, HARVARD, MA (US); SIMONE MUSSO, CAMBRIDGE, MA (US)

(73) Assignee: Schlumberger Technology Corporation, Sugar Land, TX (US)

(21) Appl. No.: 14/030,819

(22) Filed: Sep. 18, 2013

Related U.S. Application Data
(60) Provisional application No. 61/704,251, filed on Sep. 21, 2012.
(60) Provisional application No. 61/704,244, filed on Sep. 21, 2012.

(51) Int. Cl. C09K 8/42

(52) U.S. Cl. CPC C09K 8/422
USPC 166/295

(57) ABSTRACT

The isolation of selected regions downhole may be achieved using methods that include emplacing a polymerizable material within a wellbore, wherein the polymerizable material contains a polymerizable component and a latent curing agent; initiating polymerization of the polymerizable material; and forming a seal within the wellbore. Permanent or semi-permanent downhole seals may also be prepared using methods that include emplacing a section of pipe having a surrounding membrane into an interval of a wellbore, wherein the surrounding membrane contains a polymerizable material, and deploying the membrane downhole to form a seal.

### CROSS-REFERENCE TO RELATED APPLICATIONS

This application claims the benefit of U.S. Provisional Patent Application Ser. No. 61/704,251 filed Sep. 21, 2012 and U.S. Provisional Patent Application Ser. No. 61/704,244 filed Sep. 21, 2012. The entirety of each of the above-identified provisional applications is incorporated herein by reference.

### BACKGROUND

Drilling operations typically involve mounting a drill bit on the lower end of a drill pipe or drill stem and rotating the drill bit against the bottom of the hole to penetrate the formation, creating a borehole. Wellbore fluids may be circulated down through the drill pipe, out the drill bit, and back up to the surface through the annulus between the drill pipe and the annular wall. The injection of wellbore fluids can place undesirable mechanical stress on the rock around the wellbore and may even damage the reservoir. With increasing depth a hydrostatic pressure acts outwards on the borehole, which may cause mechanical damage to the formation and reduce the ability of the well to produce oil or gas.

Formation damage and fractures that occur during drilling may require shutdown of operations, removal of the drillstring from the wellbore, and repair to seal the fractures before drilling can continue. Depending on the particular operation, various treatment fluids may be emplaced downhole to remediate formation damage, including physical treatments that contain viscosifying agents or particulate solids that reduce the mobility of fluids into formation defects or form aggregates that obstruct fractures or pores downhole. Other repair methods may include use of chemical treatments that include polymer- or gel-forming components and cements that harden or set up to produce seals downhole.

Other types of formation damage include incomplete zonal isolation during completions that may stem from improper or incomplete cement placement while cementing casing or liners into place. Defects in the cementing process may lead to the generation of microannuli that appear between the fluid conduit and the cement sheath and/or between the cement sheath and the formation, or the cement may even crack, allowing the influx of undesired gases and fluids into the casing or liner. In such instances, intervention may be required to repair defects in the casing or liner before production is initiated.

Treatment fluids may be circulated through various downhole tools emplaced within the wellbore including drill strings, casings, coiled tubing and the like. A number of specialized wellbore tools may also be used to isolate regions of the wellbore during the application of various fluid treatments during repair and removal operation to aid placement. For example, a packer element may be delivered downhole on a conveyance and then emplaced against the surrounding wellbore walls to isolate a region of the wellbore. Following isolation, repair treatments may be applied to the region of formation damage and allowed to set before removing or disengaging the packer.

In addition to their use in repair operations, packers may also be used during production, when it may be necessary to shut off a water producing interval to prevent contamination of hydrocarbons generated from an oil-bearing interval. In such cases, a swellable packer may be used to isolate zones above or below a target region.

### BRIEF DESCRIPTION OF DRAWINGS

FIGS. 1A and 1B illustrate a wellsite polymerization wherein an expandable sealing element is used to isolate an interval downhole in accordance with embodiments of the instant disclosure.

FIGS. 2A-D show further detail of an expandable structure used for downhole sealing applications in accordance with embodiments of the instant disclosure.

FIGS. 3A-D illustrate an inflatable sealing structure for downhole applications in accordance with embodiments of the instant disclosure.

FIGS. 4A and 4B show a downhole sealing structure in which an expanding portion and filling material are housed in a recessed pocket in accordance with embodiments of the instant disclosure.

FIG. 5 illustrates the expansion of an elastic membrane as part of a downhole sealing structure in accordance with embodiments of the instant disclosure.

FIGS. 6A and 6B show an elastic membrane having a large expansion ratio in an unexpanded state in accordance with embodiments of the instant disclosure.

FIGS. 7 and 8 show an elastic membrane having a large expansion ratio in a partially expanded state in accordance with embodiments of the instant disclosure.

FIG. 9 shows the high expansion ratio membrane in a fully expanded state in accordance with embodiments of the instant disclosure.

FIGS. 10A and 10B are top views illustrating the expansion capabilities of an elastic membrane in accordance with embodiments of the instant disclosure.

FIG. 11 is a flow chart showing a process for downhole sealing in accordance with embodiments of the instant disclosure.

FIGS. 12A and 12B illustrate the use of a polymerizable material to seal an annular region of a wellbore in accordance with embodiments of the present disclosure.

FIG. 13 illustrates the use of a polymerizable material to repair damaged casing, formation, or cement in accordance with embodiments of the present disclosure.

FIGS. 14A-C illustrate the use of a polymerizable material in the form of a solid object or dart in secondary sealing or repair functions in order to isolate zones for multi-stage fracturing in accordance with embodiments of the present disclosure.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In one aspect, the instant disclosure is directed to methods that include emplacing a polymerizable material within a wellbore, wherein the polymerizable material contains a polymerizable component and a latent curing agent; initiating polymerization of the polymerizable material; and forming a seal within the wellbore.

In another aspect, the instant disclosure is directed to methods that include deploying an elastic membrane downhole; expanding the elastic membrane downhole; and initiating the polymerization of a polymerizable material within the membrane thereby forming a downhole seal.

In yet another aspect, the instant disclosure is directed to methods that include emplacing a section of pipe having a surrounding membrane into an interval of a wellbore, wherein the section of pipe contains one or more openings between the interior of the section of pipe and a region of the surrounding elastomeric membrane; and injecting a polymerizable material through the section of pipe and into the surrounding membrane; initiating polymerization of the polymerizable material; and forming a seal within an interval of the wellbore.

In yet another aspect, the instant disclosure is directed to methods that include emplacing a lower sealing element within an interval of a wellbore below a target region; emplacing a section of tubing or drill pipe near the target region; emplacing an upper sealing element within an interval of the wellbore above the target region; isolating the target region between the upper sealing element and the lower sealing element; injecting a polymerizable material into the isolated target region; initiating polymerization of the polymerizable material; and forming a seal within the isolated target region.

Further features and advantages of the subject disclosure will become more readily apparent from the following detailed description when taken in conjunction with the accompanying drawings.

### DETAILED DESCRIPTION

The particulars shown herein are by way of example and for purposes of illustrative discussion of the embodiments of the subject disclosure only and are presented in the cause of providing what is believed to be the most useful and readily understood description of the principles and conceptual aspects of the subject disclosure. In this regard, no attempt is made to show structural details in more detail than is necessary for the fundamental understanding of the subject disclosure, the description taken with the drawings making apparent to those skilled in the art how the several forms of the subject disclosure may be embodied in practice. For example, systems, processes, and other elements of embodiments may be shown as components in block diagram form in order not to obscure the embodiments in unnecessary detail. In other instances, well-known processes, structures, and techniques may be shown without unnecessary detail in order to avoid obscuring the embodiments. Further, like reference numbers and designations in the various drawings indicate like elements.

Also, it is noted that embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be rearranged. A process may be terminated when its operations are completed, but could have additional processes not discussed or included in a figure. Furthermore, not all operations in any particularly described process may occur in each embodiment. A process may correspond to a method, a function, a procedure, a subroutine, a subprogram, etc. When a process corresponds to a function, its termination corresponds to a return of the function to the calling function or the main function.

Furthermore, embodiments of the disclosure may be implemented, at least in part, either manually or automatically. Manual or automatic implementations may be executed, or at least assisted, through the use of machines, hardware, software, firmware, middleware, microcode, hardware description languages or any combination thereof. When implemented in software, firmware, middleware or microcode, the program code or code segments to perform the required tasks may be stored in a machine readable medium. A processor(s) may perform the required tasks.

The present disclosure relates to methods of zonal isolation, sealing, remedial casing patch operations, and other wellbore operations. Methods described herein may utilize polymerizable materials for remediation of formation damage and repair seals in casings, tubular, and/or cements present downhole.

In one or more embodiments, methods may utilize latent curing polymerizable materials that are emplaced as a single composition or series of compositions and cure upon a triggering stimulus such as a change in temperature, pH, solubility, etc. Latent curing polymerizable materials described herein may be useful for sealing of irregular shapes, formation of primary or secondary seals, installation of temporary or permanent plugs in casings and liners, or for general wellbore strengthening applications. Other applications may involve mitigation of unplanned events, zone shutoff, secondary sealing applications, and well abandonment.

In some embodiments, the polymerizable material may not react until triggered by applying elevated temperatures encountered downhole or at the surface prior to emplacement for a given length of time. The latency of polymerizable is dependent on the selected chemistry, which may be adjusted to various time intervals to suit a variety of applications. Upon initiation of polymerization the polymerizable material may transition from a liquid state to a solid, semi-solid, or foamed state as the polymerizable material cures.

In another aspect, the present disclosure is directed to repair and completions operations that utilize downhole tools that contain settable and/or expandable elements that may be used as, for example, packers or bridge plugs that create permanent or removable seals downhole. Particular embodiments in accordance with the present disclosure are directed to downhole tools that contain or are configured to receive polymerizable materials and/or a latent curing agent that set in response to appropriate conditions downhole. Downhole tools described herein may also employ flexible, expandable and/or elastomeric elements that expand. In one or more embodiments, an expandable element is emplaced downhole on casing string, drill pipe, drill collar string or coil tubing as part of a tool sub assembly.

Packers in accordance with the instant disclosure may be emplaced within a wellbore on wireline, pipe, or coiled tubing to perform sealing applications and may be permanent, removable by drilling or milling, or retrievable. In embodiments directed to completions, packer elements in accordance with the present disclosure may be used to isolate the annulus from the production conduit, enabling controlled production, injection or treatment. Packer assemblies may incorporate a means of securing the packer against the casing or liner wall, such as a slip arrangement, and a means of creating a reliable hydraulic seal to isolate the annulus such as an expandable elastomeric element or membrane. When applied to production applications, embodiments described herein may be employed as a production packer that isolates the annulus and anchors or otherwise secures the bottom of a production tubing string. It is also envisioned that embodiments of packer designs described herein may be modified to suit the wellbore geometry and production characteristics of the reservoir fluids.

In one or more embodiments, a polymerizable material within a packer may be triggered with an elevated temperature at the surface or when exposed to elevated temperatures downhole. In other embodiments, a polymerizable material may be injected into a packer or elastomeric membrane present on a tool from an external source to initiate expansion. Polymerizable materials may be introduced into a packer as a liquid, gel, or solid, and elevated downhole temperatures may trigger polymerization to produce a seal. In further embodiments, a curing agent may be present in the packer prior to emplacement, such as in the form of a coating within an inflatable membrane. The curing agent then may react to initiate curing, swelling, foaming, hardening, etc., upon contact with a polymerizable material present or subsequently introduced into the packer downhole.

During wellbore operations, once a packer is located at a desired depth, an operation to set the packer may be performed including, in non-limiting examples, increasing pressure within the casing to longitudinally compress the element, using drill pipe weight to compress the element, inflating the packer, injecting a polymerizable mixture and/or curing agent (in the case of hollow or partially filled sealing elements), triggering a capsule to form a polymerizable mixture prior to hardening, or any combination of the above.

In some embodiments, the composition of the polymerizable material within a packer determines the temperature to trigger the reaction and the latency between the start of the reaction until the compound is fully hardened. After an exposure time to an elevated temperature of the downhole environment, the polymerizable material may cure, foam, and/or harden within the flexible membrane. Once set, a flexible membrane present on the packer may form a seal by contouring against the formation or casing wall. In addition to application as zonal isolation packers, embodiments described herein may also be configured as, in non-limiting examples, casing patch packers, liner top packers and bridge plugs.

Packers in accordance with embodiments of the present disclosure may be installed on a section of pipe such as a drillstring or coiled tubing and emplaced within a wellbore. In certain embodiments, at a specified depth, or in response to a triggering event such as an elevated temperature or the injection of a polymerizable material or curing agent, the packer may expand in order to form a seal within an interval of the wellbore. In some embodiments, polymerization or generation of a foam from a polymerizing material within a packer may cause the packer to expand and engage the walls of a formation, surrounding casing, or liner. Further, upon completion of a desired operation, packers may be removable in some embodiments. For example, emplaced packers may be drilled or milled through once zonal isolation is no longer required.

In another aspect, a packer in accordance with embodiments of the present disclosure may possess a small initial outside diameter prior to emplacement within a wellbore and may be expanded to form a seal that isolates one or more regions downhole. For example, a packer may be an inflatable packer that uses one or more expandable membranes that swell and wedge the packer against a surrounding casing or wellbore. Inflatable packers may contain an elastomeric membrane constructed from an elastomeric material such as nitrile rubber (NBR), hydrogenated nitrile butadiene rubber (HNBR), and fluorocarbon rubber (FKM). The expandable membrane may be compliant and occupy a small annular cross-section in order to be run in hole without catching, ripping, or tearing in some embodiments. The inflatable packer may contain a volume of polymerizable material or may be configured such that a polymerizable may be injected into the packer when the isolation of a region within the wellbore is desired. The polymerizable material may react and harden, providing rigid support for the packer to form a seal and withstand differential pressure applied to the packer.

In preparation for setting an inflatable packer, a drop ball or series of tubing movements may be required. Hydraulic pressure may also be provided by applying surface pump pressure in order to inflate the packer. Suitable inflatable packers may be capable of relatively large expansion ratios in some embodiments, which may be used in through-tubing work where tubing size or completion components may impose size restrictions on devices designed to set in the casing or liner below the tubing.

In other embodiments, a packer may be a compression-set packer such as a production packer or test packer. Compression-set packers in accordance with the instant disclosure may be activated or set by applying compressive force to the packer assembly and then triggering the polymerization of a polymerizable material to set the packer by the addition or activation of a curing agent. In one or more embodiments, the compressive force may be generated from the set-down weight from the running string, which squeezes the packer element between two plates, forcing the sides to bulge outward. For example, at least one packer containing a polymerizable material and a latent curing agent may be positioned on a tool or drillstring, and may be expanded by compressing the bladder between mechanical elements, causing the bladder to expand outward radially. Once the packer is compressed into place, activation of curing agent then causes the polymerizable material to harden to generate a seal at a target region.

To facilitate a better understanding of the present disclosure, the following examples of certain embodiments are given. In no way should the following examples be read to limit, or define, the scope of the present disclosure.

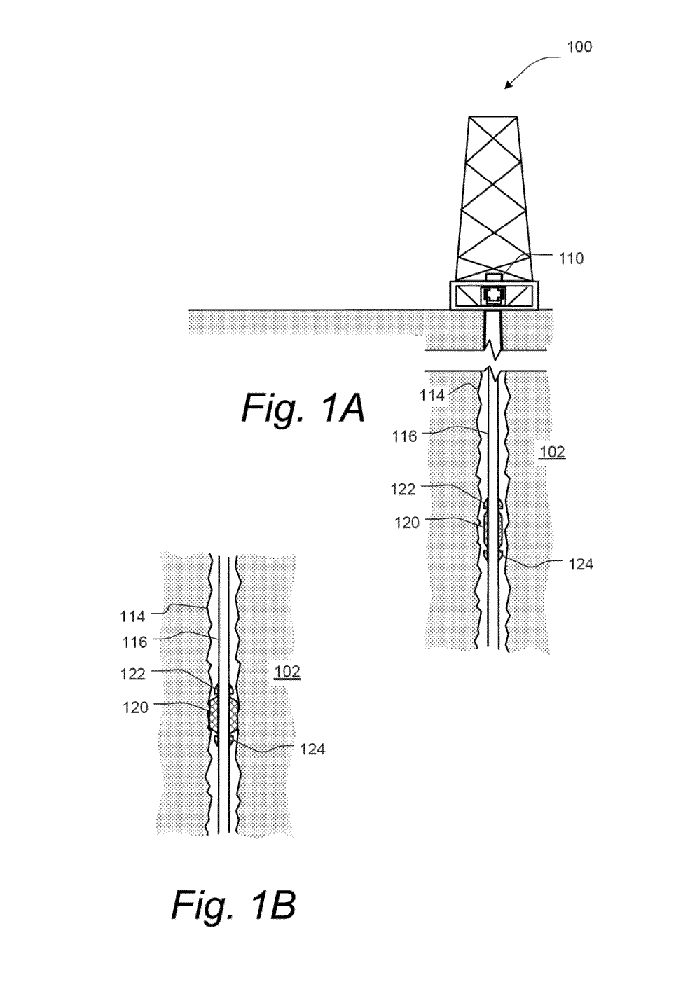

With particular reference to FIGS. 1A and 1B, a wellsite setting is shown, wherein an expandable membrane in accordance with embodiments of the present disclosure is used to create a seal within a wellbore. In FIG. 1A, wellsite 100 includes a wellhead 110 and a wellbore 114 that penetrates a subterranean formation 102. Deployed on casing 116 is an expandable packer 120 that may used for sealing applications. Also shown surrounding the upper and lower portions of membrane 120 is an upper flange 122 and lower flange 124 which are dimensioned so as to protect the membrane 120 during deployment downhole. FIG. 1B shows the membrane 120 in an expanded state thereby forming a seal against the walls of the wellbore 114 in formation 102.

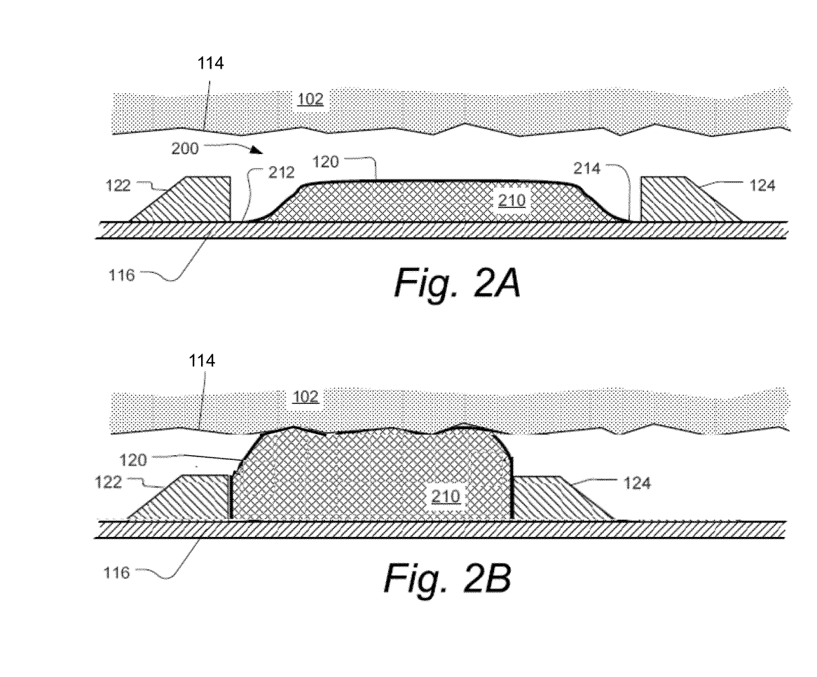

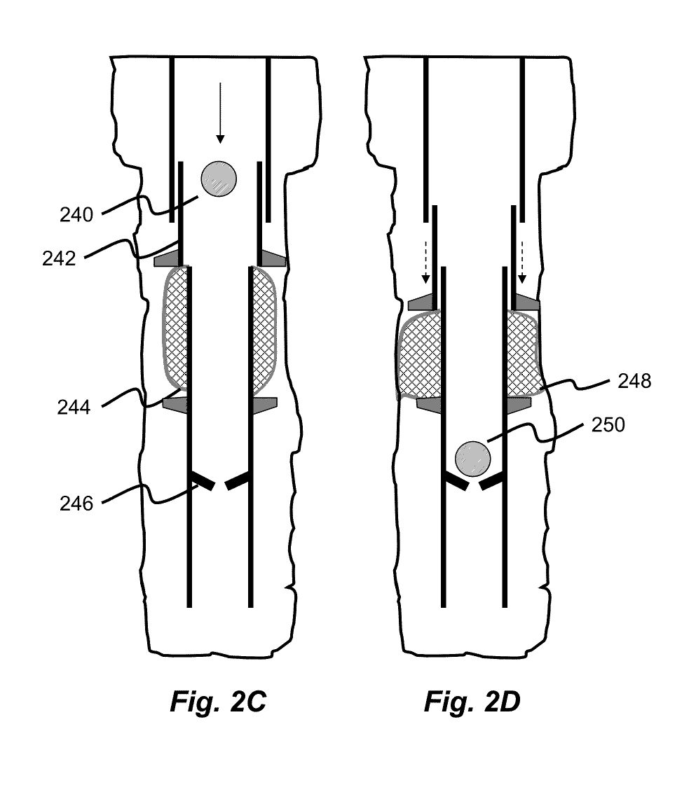

With particular reference to FIGS. 2A and 2B, further detail of a swellable or expandable structure such as a packer used for downhole sealing applications in accordance with some embodiments is shown. FIG. 2A shows the structure 200 in its initial, un-expanded state, while FIG. 2B shows the structure in its expanded, sealing state. The structure 200 includes an elastic membrane 120 which forms a pocket in which polymerizable material 210 is enclosed. According to one embodiment, the membrane 120 completely surrounds the material 210, and according to other embodiments, the membrane 120 is sealed at ends 212 and 214 such that the material 210 is enclosed by a combination of membrane 120 and the casing wall 116. The upper and lower flanges 122 and 124 are provided to protect the structure 200 during deployment downhole. FIG. 2B shows the structure in an expanded state after the application of a compressive forces against membrane 120 such as by the actuation of flange 124 and/or flange 122. During compression, the expandable structure 200 may deform outwardly to contact the formation or an exterior section of pipe prior to or during curing of the polymerizable material. Compressive forces that may actuate mechanical structures present on the tool to deform expandable structure 200 may include hydraulic force, tool rotation, the set-down weight of the tool, or other means know in the art. In yet other embodiments, at least a portion of the expansion of the expandable structure 200 may be due to the increase in volume of polymerizable material 210 due to polymerization and/or the formation of a foam.

With particular respect to FIGS. 2C and 2D, the use of a hydraulic piston, such as a Falcon ball drop multi-zone isolation systems, is illustrated for a particular embodiment of the instant disclosure. For example, in the embodiment illustrated in FIGS. 2C and 2D, an expandable packer 244 containing a polymerizable material may be compressed and set by a sliding sleeve 242 that is activated from the increase in pressure caused by sealing an interval of the drill string with a ball 240 dropped from surface. The ball 240 may travel the length of the lateral well to its intended operational depth, at which it meets a mated seat 246 and isolates the wellbore below. Once the ball is in position 250, the sliding sleeve 242 opens via the hydraulic force at a target pressure, initiating compression of the expandable packer 244 effectively creating a seal 248. In some embodiments, the packer may have an internal lock ring that maintains the setting force on the expandable packer, allowing the packer to handle multiple pressure reversals at elevated temperatures. Once the expandable packer 244 is set, polymerizable materials present within the membrane may cure or harden, creating a permanent or semi-permanent seal that conforms to the surrounding formation or an external casing, for example.

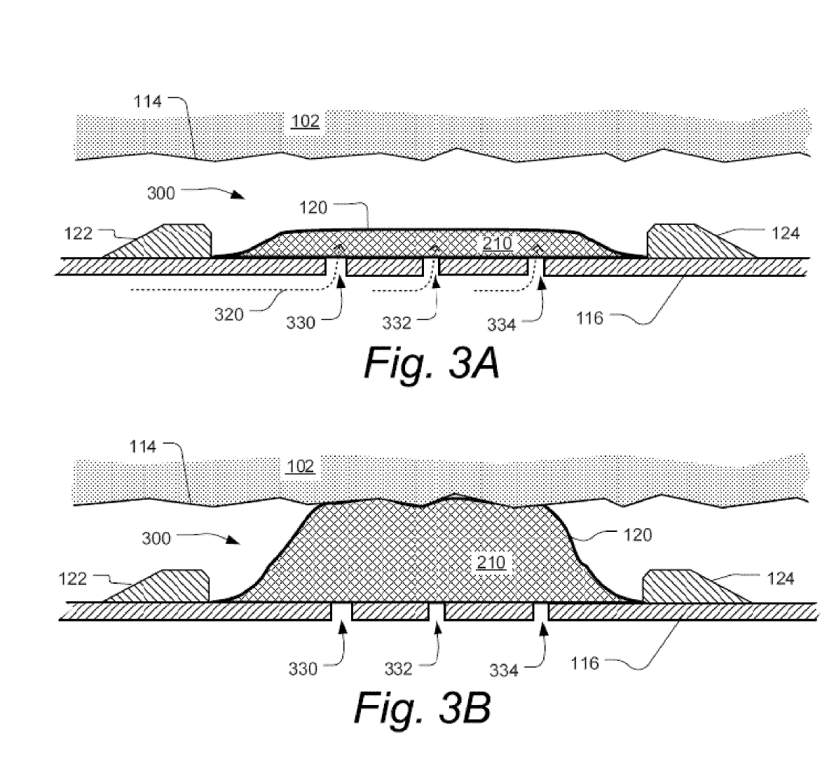

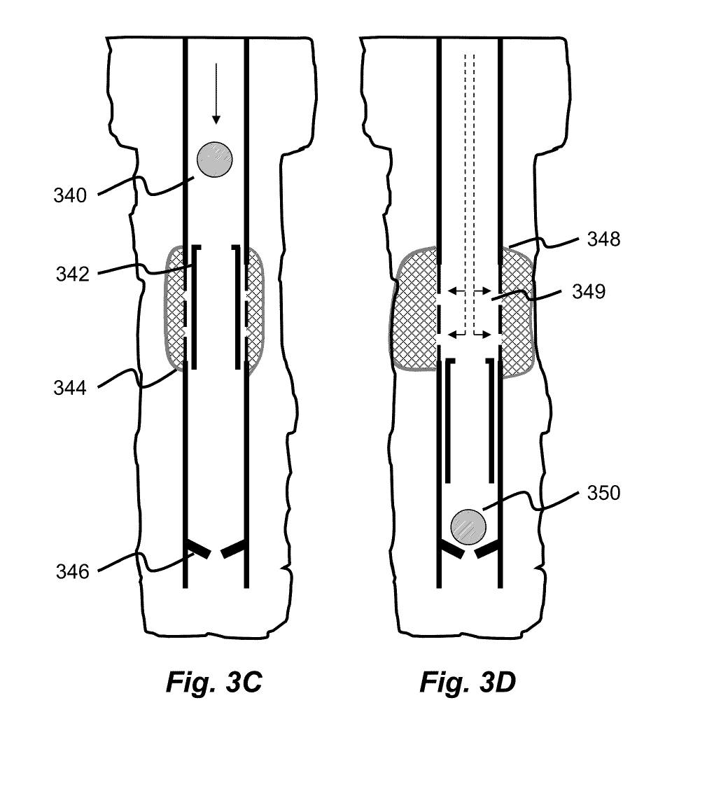

In another embodiment, at least one packer positioned on a section of pipe may be configured such that whenever fluids pumped through the section of pipe enter the surrounding expandable packer through one or more passages or openings. With reference to FIGS. 3A and 3B, FIGS. 3A and 3B illustrate a sealing structure for downhole applications, according to some other embodiments. According to some embodiments the structure 300 shown in FIGS. 3A and 3B, contains a membrane 210 that may be expanded by injecting a polymerizable material and/or curing agent through orifices 330, 332 and 334 in the casing wall 116. According to some of the embodiments of FIGS. 3A and 3B, at least one of the polymerizable material and/or curing agent are enclosed in the membrane 120 prior to deployment of the structure 300, then when sealing using structure 300 is desired, a second component is injected through the orifices 330, 332 and 334 to initiate polymerization. For example, where the component enclosed in the membrane is a curing agent the second component added may be a polymerizable material and vice versa.

In other embodiments, expandable packers of the instant disclosure may incorporate technologies such as a ball sealer to divert fluid flow into a membrane surrounding an interior section of pipe. With particular reference to FIGS. 3C and 3D, a ball sealer 340 may be incorporated into a treatment fluid and pumped downhole. The ball sealer may be dimensioned such that it travels through a section of drill string until fluid pressure lodges the sealer on seat 346 forming a fluid-tight seal 350. The seal 350 creates increased pressure as additional fluid is pumped in from the surface, which displaces sleeve 342 at a target pressure allowing fluid to enter exposed membrane ports 349. Entering fluids that may include a polymerizable material and/or a latent curing agent are then directed into elastomeric membrane 344, expanding the membrane to contact an exterior surface such as a formation wall or casing. Once the expandable packer is deployed, triggering events such as an increase in temperature or subsequent introduction of a curing agent cause the polymerizable material to set generating a permanent or semi-permanent seal 348. In particular embodiments, suitable ball sealer systems that may be incorporated into expandable packers include Falcon ball drop multi-zone isolation systems commercially available from Schlumberger Technology.

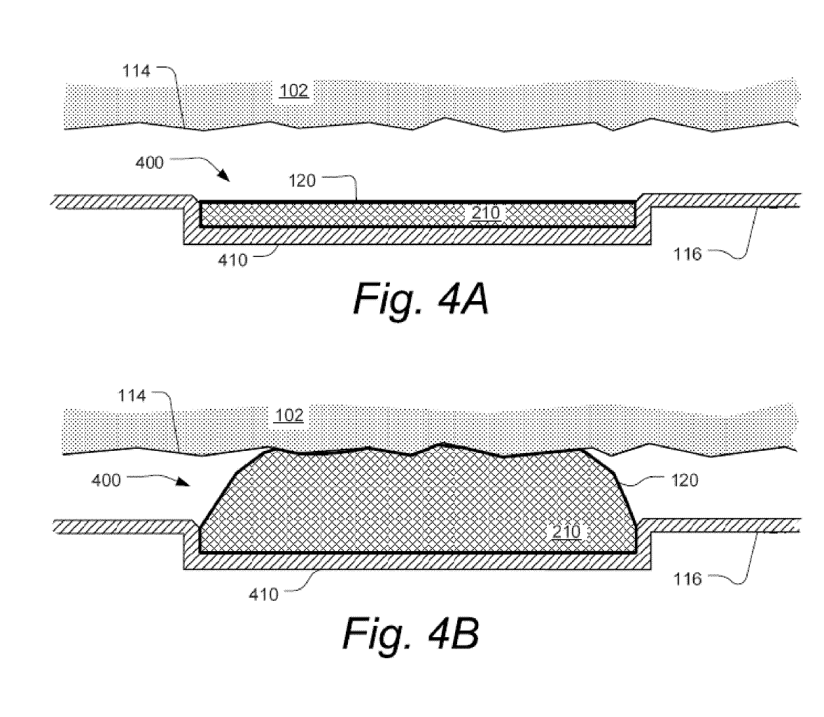

FIGS. 4A and 4B illustrate a downhole sealing structure in which an expanding portion and a filling material are housed in a recessed pocket, according to some embodiments. The sealing structure 400 is initially housed within the recessed pocket 410 of the casing, liner, drill pipe, or coiled tubing 116. This design may protect the sealing structure 400 during deployment downhole without the use of additional flanges.

Additionally, some embodiments may incorporate orifices in the casing 116 to allow the injection of polymerizable materials and/or curing agents into the pocket 210 created in membrane 120. A polymerizable material and latent curing agent may be emplaced in the pocket 210 created by the membrane, and in response to a triggering event, such as an increase in temperature or the passage of a predetermined amount of time, an increase in volume triggered by the polymerization of the polymerizable material and/or the generation of a foam causes the membrane 120 to expand against formation wall 102.

Although the sealing applications shown in FIGS. 2A-D, 3A-D, and 4A-B are for sealing between casing 116 and borehole wall 114, according to some embodiments, the same or similar structures, materials and reaction/activations are applied to sealing structures for tubing, such as production tubing within other tubing or within casing in oilfield applications.

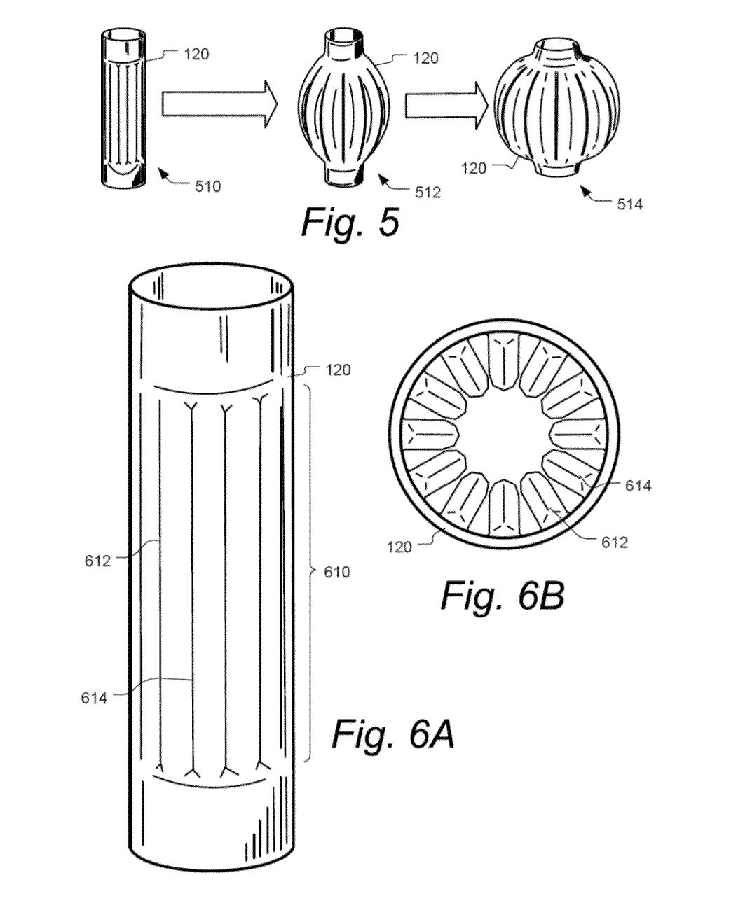

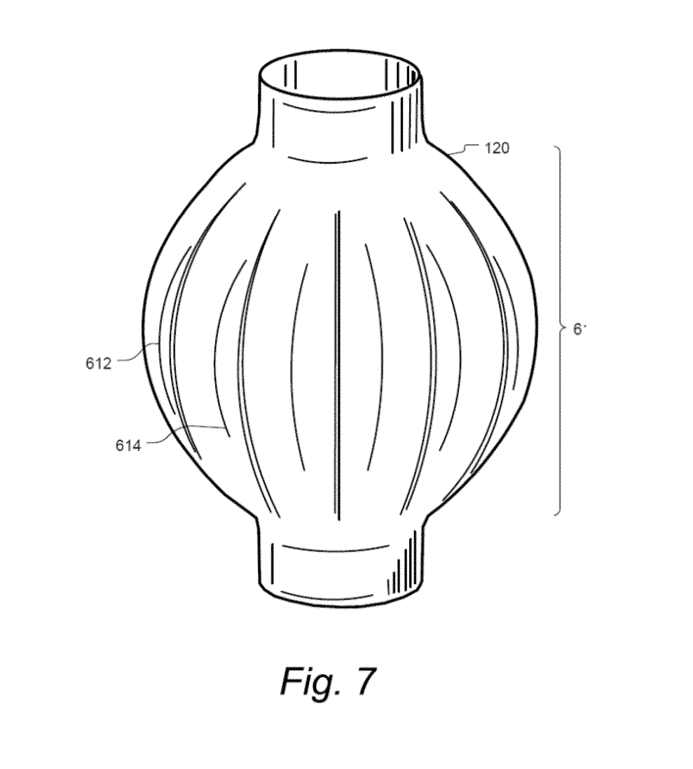

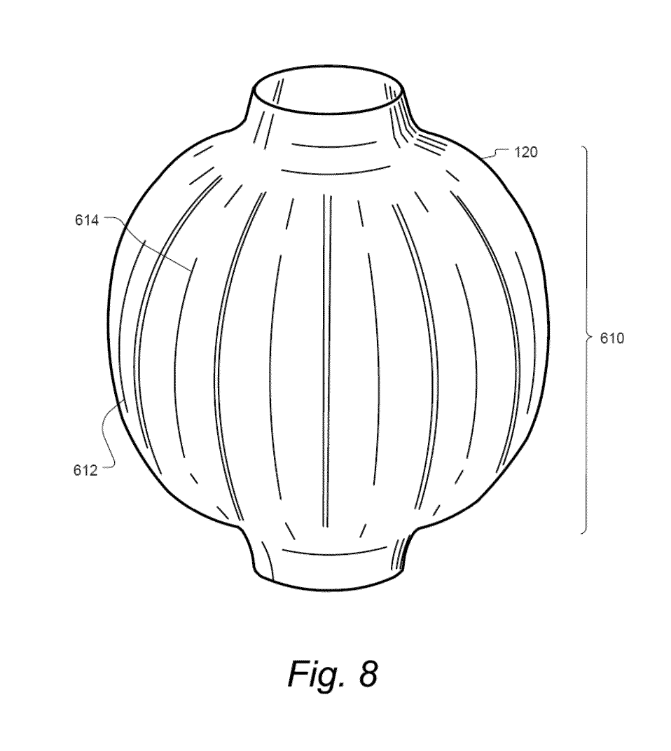

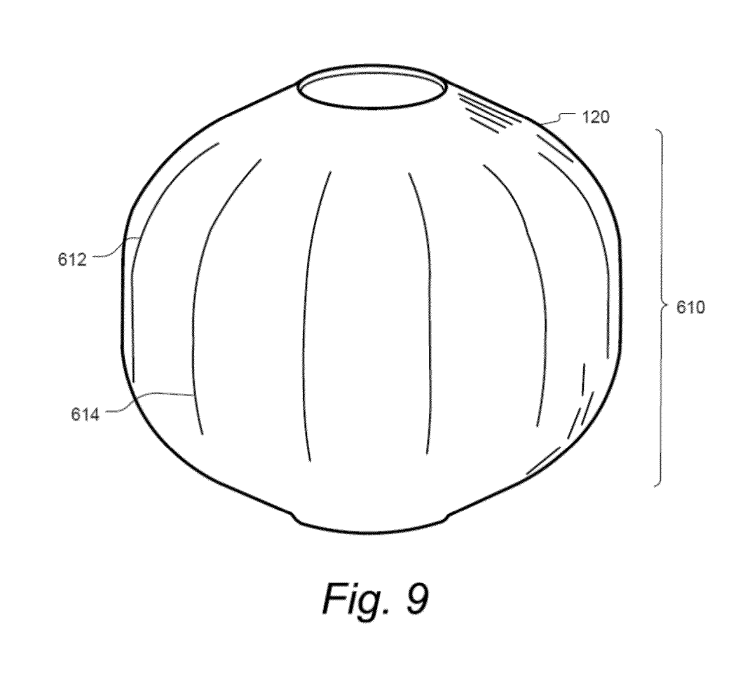

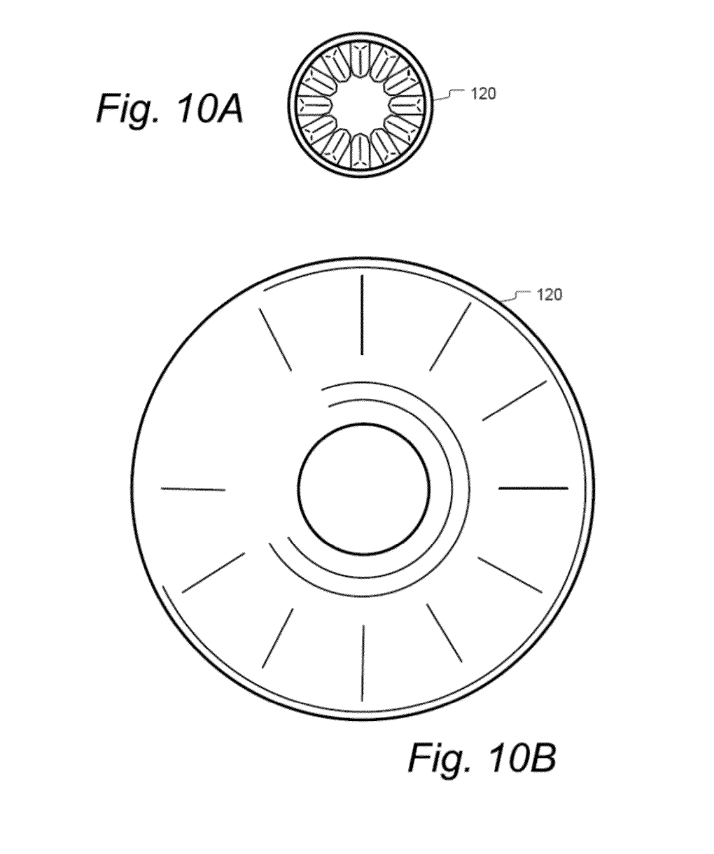

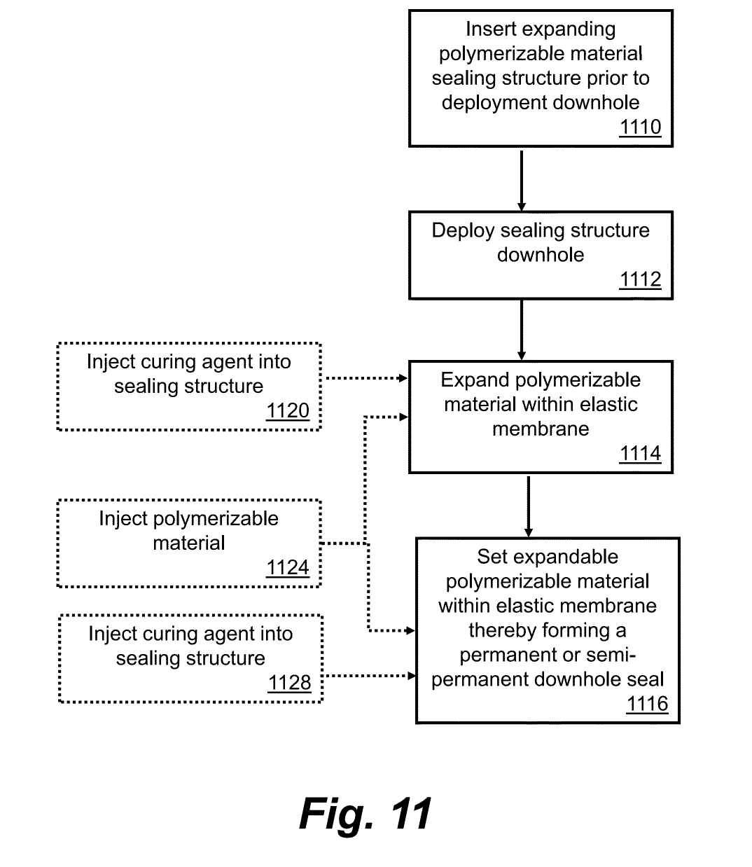

FIG. 5 illustrates the expansion of an elastic membrane as part of a downhole sealing structure. Membrane 120 in state 510 is un-expanded. State 512 shows partial expansion and state 514 shows membrane 120 fully expanded. FIGS. 6A and 6B show an elastic membrane having a large expansion ratio in an unexpanded state, according to some embodiments. In FIG. 6A, membrane 120 has a folded section 610 that includes multiple pleated-type folds, such as folds 612 and 614 that allow for additional membrane material to be included. FIG. 6B is a top view showing the inner side of the folded section including folds 612 and 614. FIGS. 7 and 8 show an elastic membrane having a large expansion ratio in a partially expanded state, according to some embodiments. As can be seen, the folded section 610, including folds 612 and 614 that allow for additional membrane material. Thus, expansion is provided both from stretching of the elastic material 120 and also through unfolding of the folded membrane material. FIG. 9 shows the high expansion ratio membrane in a fully expanded state, according to some embodiments. Membrane 120 is fully expanded and folded section 610 including folds 612 and 614 are fully unfolded. FIGS. 10A and 10B are top views illustrating the expansion capabilities of an elastic membrane according to some embodiments. FIG. 10A shows the membrane 120 in an unexpanded state and FIG. 10B shows the membrane in a fully expanded state. While extraneous structures are omitted from FIGS. 5 to 10 for clarity, an expandable membrane (or expandable membranes) as described in these figures may be incorporated in any of the tools or methods described in the present disclosure.

In one or more embodiments, the membranes incorporated in tools and methods of the present disclosure may be an elastic membrane that has large expansion ratio with respect to the unexpanded state of the respective membrane. The membrane may have a folded section that includes multiple pleated-type folds, that allow for additional material to be included. In one or more embodiments, the elastic membrane is adapted to expand by at least 100% in size with respect to its initial dimensions. In other embodiments, the elastic membrane is adapted to expand by a percentage within a range having a lower limit selected from 100%, 120%, 150%, and 200% of the initial size of the elastomeric membrane to an upper limit selected from 120%, 150%, 200%, and 250% of the initial size of the elastomeric membrane.

It is also within the scope of this disclosure that packer-based methods described herein may also be practiced using multiple packers positioned independently or as part of a multi-packer configuration on a single tool or section of pipe. For example, methods may utilize a dual packer configuration in which an interval to be treated may be isolated between two packer elements. Two or more packers may be used to isolate one or more regions in a variety of well related applications, including production applications, service applications, and testing applications. In other applications, two packers separated by a spacer of variable length, or straddle packer, may be used to isolate specific regions of the wellbore to allow for localized delivery of treatment fluids or collection of fluid samples.

FIG. 11 is a flow chart showing a process for downhole sealing according to some embodiments. In process 1110, the expandable polymerizable material is placed inside a sealing structure prior to deployment downhole. For example, according to some embodiments, the material is placed in the sealing structure within the expandable membrane during manufacture of the sealing structure. In process 1112, the sealing structure and polymerizable material are deployed downhole. In process 1114 the sealing structure is expanded. As described herein, in process 1120 a curing agent may be used to initiate a reaction that causes an expansion of the sealable element. According to some embodiments, in process 1114, the polymerizable material also contains a latent curing agent that initiates the expansion of the expandable membrane. In yet other embodiments, process 1114 may involve a physical compression of the expandable membrane to force the membrane outward to contact a formation or exterior section of pipe. In process 1124, according to some embodiments, polymerizable material pumped into the structure via orifices in the structure. In process 1116, the expandable polymerizable material is set while the structure is in its expanded state such that a solid mass is formed within the membrane, and a permanent or semi-permanent downhole seal is formed. According to some embodiments, a curing agent may also be introduced or activated at process 1128, while the membrane is in an expanded configuration to aid in the expansion and/or polymerization of the material within the elastic membrane.

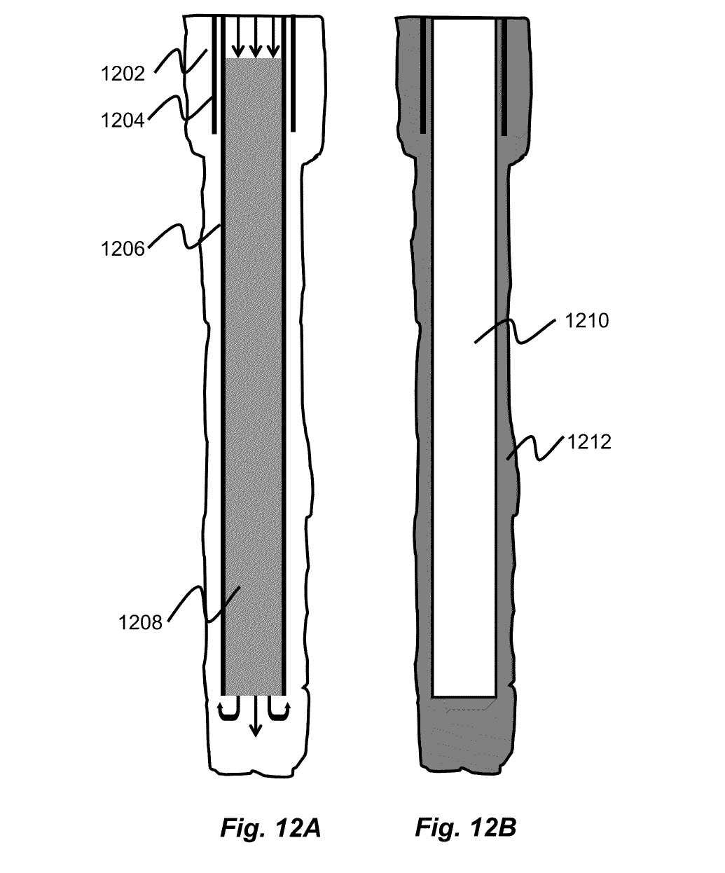

In one or more embodiments, the polymerizable material may be mixed with a latent curing agent and emplaced within the wellbore as a treatment fluid useful to repair regions of formation damage or defects in cement linings. With particular respect to FIGS. 12A and 12B, a polymerizable material 1208 may be pumped through the inner diameter of the casing 1204 and up into the annulus between the casing and formation 1202, or liner and formation 1206, where the polymerizable material may cure and form a seal 1212 in the selected interval. In some embodiments, a spacer fluid 1210 may be used to drive the fluid containing the polymerizable material into place. Once emplaced, the polymerizable material may equilibrate to an elevated temperature in the wellbore, which may then initiate polymerization of the material in some embodiments. In yet other embodiments, activation may be initiated by a curing agent that has been previously, concurrently, or subsequently injected (with respect to the polymerizable material) into the void space or formation damage to be sealed. The polymerizable material may be pumped downhole to increase rigidity and isolate between zones, to squeeze into cracks or imperfections in an existing cement job or as a way to permanently plug or abandon a well.

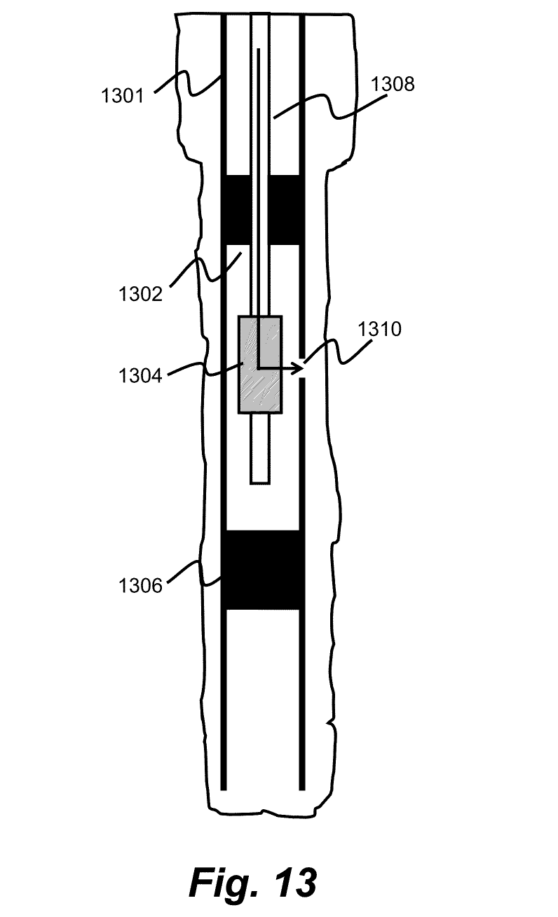

With particular respect to FIG. 13, a polymerizable material mixture may be pumped through the inner diameter of coil tubing or drill pipe and then directed by a tool 1304 into the damaged area to harden and form a seal in a repairing application. Once damage to the liner, cement, or formation behind the casing or liner is detected, polymerizable material may be pumped as a liquid form and directed by a tool string on drill pipe, coil tubing, or wireline to repair the damaged section. In one or more embodiments, a polymerizable material may be pumped into a region isolated by packing elements in order to seal damaged casing, formation, or previously emplaced cement. For example, in FIG. 13 a casing or liner 1301 may contain an isolated interval separated by an upper sealing element 1302 such as a retrievable packer and lower sealing element 1306 such as a bridge plug. In other embodiments, elements 1302 and 1306 may represent the paired packer elements of a straddle packer (not shown). Once the region of formation damage 1310 is isolated, a polymerizable material and/or curing agent may be pumped through the inner diameter of a drill pipe, coiled tubing or wireline 1308 and delivered to a damaged region 1310 of the formation or casing using, for example, a directional tool 1304. The polymerizable material may be also be pumped through the liner shoe into an existing cement job as in a squeeze operation to repair cracks, imperfections, or channeling. The polymerizable material may also be pumped and cured through the entire well in plugging or abandonment applications.

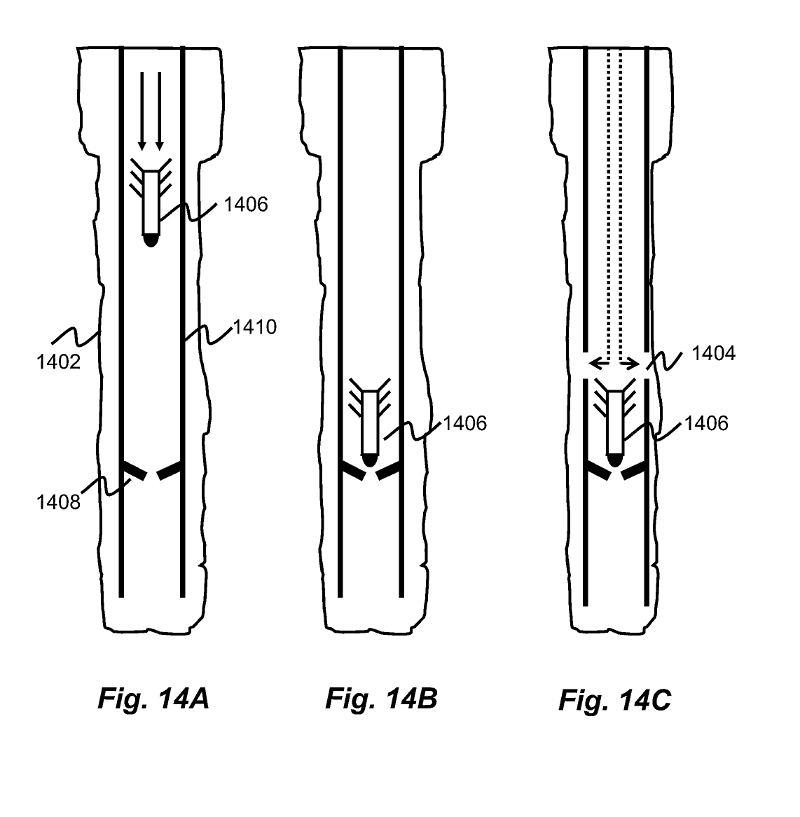

FIGS. 14A-C depict a wellbore operation wherein a polymerizable material 1406 is emplaced downhole as a solid slug, a “dart-like object,” or as part of a mechanical dart assembly within a wellbore fluid. In embodiments, the polymerizable material 1406 is emplaced downhole and lands on a seat 1408 within casing 1410 to perform primary sealing functions or on a bridge plug to aid in secondary sealing or repair functions in order to isolate zones for multi-stage fracturing. Once in a desired position, elevated downhole temperature can cause the polymerizable material to cure and form a solid sealing material. The dart or object may also function to open a path 1404 between casing 1410 and formation 1402 to allow for a fracturing fluid to enter the formation. In some embodiments, the sealing component and/or body of the dart or object is made wholly or partially out of a polymerizable material. In addition to ease of installation, sealing elements formed from polymerizable materials may also be removed by drilling through the seal or dissolving the polymer with a suitable solvent.

### Polymerizable Materials

Polymerizable materials may be pumpable or injectable in some embodiments, and may be pumped into the wellbore from the surface in a solid and/or liquid form in other embodiments. In one or more embodiments, the polymerizable material may be emplaced into an annulus, tubing, casing, liner, or other form of drill pipe present within a reservoir. In yet other embodiments, the polymerizable material may be injected into a vessel emplaced downhole such as a membrane or inflatable packer positioned on a section of drill pipe or tubing.

According to other embodiments, the polymerizable material is a pliable solid, or a fluid. In other embodiments, polymerizable materials may swell and/or set, such as polymer-forming materials and polymeric foams. It is also envisioned that, in some embodiments, a fluid may be introduced to facilitate or trigger the expansion and/or polymerization of the polymerizable material once emplaced. The introduced fluid may be injected directly into the region containing the polymerizable material or diffused through a membrane surrounding the polymerizable material. According to other embodiments, the polymerizable material is expanded and/or set upon exposure to external triggers that include, for example, temperature changes and/or pH changes. According to some embodiments, a curing agent or initiator is added to a polymerizable material to trigger a polymerization and/or swelling reaction, or may be present in the polymerizable material in an inactive state that is converted to an active state upon exposure to an appropriate stimulus in other embodiments.

In accordance with one or more embodiments of the present disclosure, a polymerizable composition may include a system for producing a polymeric mass from the polymerization of a suitable polymerizable species including monomers, mixtures of monomers, oligomers, or prepolymers. In addition to polymerizable species, polymer-forming compositions may include one or more initiators, activatable initiators, activatable initiator complexes, blowing agents, and/or other polymer additives known in the art such as plasticizers, stabilizers, curing agents, and the like.

In one or more embodiments, the polymerizable material may contain polymerizable monomers or prepolymers that polymerize through a cationic ring opening mechanism. As used herein, the term prepolymer refers to a monomer or system of monomers that has been reacted to an intermediate weight state (between monomer and polymer) but is still capable of further polymerization to a fully cured high-molecular weight state. In one or more embodiments, suitable cyclic monomers may be selected, for example, from one or more of heterocyclic monomers including lactones, lactams, cyclic amines, cyclic ethers, oxiranes, thietanes, tetrahydrofuran, dioxane, trioxane, oxazoline, 1,3-dioxepane, oxetan-2-one, and other monomers suitable for ring opening polymerization. In other embodiments, the polymerizable species may also be selected from one or more of an epoxy resin or diepoxide including, but not limited to trimethylolpropane triglycidyl ether, diglycidyl ether of neopentyl glycol, epoxidized 1,6-hexanediol, 1,4-butanediol diglycidyl ether (BDDGE), 1,2,7,8-diepoxyoctane, 3-(bis(glycidoxymethyl)-methoxy)-1,2-propanediol, 1,4-cyclohexanedimethanol diglycidyl ether, 4-vinyl-1-cyclohexene diepoxide, 1,2,5,6-diepoxycyclooctane, and bisphenol A diglycidyl ether, and the like.

Other monomers that may be used in embodiments of the present disclosure include any monomer that polymerizes under cationic polymerization conditions including, but not limited to, olefins, alkenes, cycloalkenes, dienes, isobutenes, natural rubbers, unsaturated fatty acids, vinyl ketones, alkoxy alkenes, vinyl ethers, vinyl acetates, vinyl aromatics, styrene, and the like.

In one or more embodiments, when the application requires an increase in the overall volume of a polymerizable material to form an efficient seal, a foam may be generated during curing of the polymerizable material. In some embodiments, foaming may be an intrinsic part of the polymerization process of a polymerizable material. However, in some embodiments the use of a blowing agent, such as a physical or chemical blowing agent, may be needed to generate pockets of gas that are subsequently entrained in the curing polymerizable material. Physical blowing agents in accordance with embodiments of the present disclosure may volatilize due to the presence of applied heat or due to the heat produced during an exothermic polymerization process. In one or more embodiments, physical blowing agents may include liquid blowing agents, hydrocarbons such as propane, butane, pentane, isopentane, cyclopentane, and other hydrocarbons having suitable boiling points or vaporization pressures for the desired application and/or polymerizable material. Chemical blowing agents that generate gaseous byproducts during curing of a polymerizable material may also be used. In one or more embodiments, suitable chemical blowing agents may include hydrazine, hydrazides, nitrates, azo compounds such as azodicarbonamide, cyanovaleric acid, and other nitrogen-based materials, sodium bicarbonate, and other compounds known in the art.

Polymerizable materials in accordance with embodiments disclosed herein may be pumped downhole as a non-viscous liquid and cured to generate a solid that forms a seal downhole, or may be displaced down hole as a solid capable of transitioning into a liquid at a given temperature and then crosslinked to generate a solid material that may form a seal. It is also envisioned that a combination of any of the above described classes of monomers and polymer-forming materials may be used depending on the desired polymer characteristics and/or modified in response to the unique properties of a given formation.

In one or more embodiments, polymerizable materials useful for described methods may provide for chemical control over latency and cure time, and may allow passive or active triggering of polymerization. In some embodiments, the curing time of the polymerizable material may be tuned to allow for slower or quicker curing depending on the particular application. This may be achieved in some embodiments by modifying latency (working time) through chemical means or designing the system such that an internal or external stimulus triggers the polymerization of the material. In some embodiments, the polymerizable material may be a thermoset material that sets in response to a change in temperature, allowing polymerizable materials to be emplaced and then reacted to form a desired morphology. For example, polymerizable materials in accordance with the embodiments disclosed herein may be employed in methods of sealing intervals within a wellbore in order to create a plug, bridge, or seal.

### Curing Agents

Suitable curing agents may be selected depending on the corresponding polymerizable material or materials used in the particular application. In embodiments of the instant disclosure in which the polymerizable material contains at least a portion of polymerizable material a curing agent may be added to trigger polymerization. In other embodiments, the curing agent may be a latent curing agent that imitates polymerization of a polymerizable material in response to appropriate conditions downhole such as elevated temperature, sufficient passage of time, changes in pH, etc. Because a number of polymerizable systems are described in the present disclosure, the type of initiator used will be highly dependent on the polymerization mechanism used for a given application, e.g., radical, cationic, or anionic polymerization. However, these distinctions will be readily apparent to one skilled in the art.

In one or more embodiments, Lewis acids may be used to initiate cationic polymerization of a polymerizable material. Lewis acids may be selected from, for example, one or more of SnCl₄, AlCl₃, BF₃, TiCl₄, and the like. Although a Lewis acid alone may be sufficient to induce polymerization in certain embodiments, a suitable cation source may be added to increase the rate of polymerization. The cation source may be aqueous fluids, alcohols, ammonium salts, or carbocation donors such as esters or an anhydrides. In embodiments containing a Lewis acid and cation source, the Lewis acid is referred to as a coinitiator while the cation source is the initiator. Upon reaction of the initiator with the coinitiator, an intermediate complex may be formed, which then reacts with available monomers or forming polymers. Counterions produced by the initiator-coinitiator complex are less nucleophilic than Brønsted acid counterions. Halogens, such as chlorine and bromine, can also initiate cationic polymerization upon addition of the more active Lewis acids.

In some instances, the use of standard initiators may result in polymerization reactions that occur too vigorously to control, resulting in poor control over molecular weight, polydispersity, and quality of the resulting polymer. In order to decrease the reaction rate, initiators based on stabilized complexes that rely on dynamic equilibrium that alternates between a stable non-reactive state and a reactive initiator state may be employed in some embodiments. In this case, control of the reaction speed is effected by increasing the stability of the non-reactive state with respect to the active initiator state.

For example, a BF₃-ammonium complex may be an alternative initiator to the use lone Lewis acid curing agents mentioned above. Suitable ammonium cations may have the formula N(R)₄⁺ in some embodiments, where R is selected from among hydrogen, alkyl, hydroxyalkyl, and aryl, and each R may be the same or different with respect to the remaining R groups. In one or more embodiments, the ammonium cation may comprise a para and/or meta substituted aryl anilinium. In more particular embodiments, the para and/or meta substitution of the anilinium cation may include a moiety and/or combination of moieties from the group including halogen, methoxy, hydroxyl, hydrogen, and alkyl chains. In even more particular embodiments, the anilinium cation may be a 4-halo-anilinium.

BF₃-ammonium complexes are unique in that the nature of the ammonium in the complexes may be varied to alter the curing rate. Although the Lewis acid of the BF₃-amine complex can, in principle, initiate the cationic polymerization of a monomer, it has been established that the true active initiator species is the superacid ammonium tetrafluoroborate, which is present in the form of an ammonium tetrafluoroborate in equilibrium with the superacid and the neutral amine. The ammonium tetrafluoroborate complex may be formed in the presence or absence of water and/or solvents. When water is present in excess relative to HBF₄, the latter behaves as a strong acid with the formation of hydronium ions, H₃O⁺, which may also serve as a cationic polymerization initiator.

In some embodiments, the curing agent may be a supramolecular complex containing an initiator that has been passivated through a stabilizing interaction with one or more stabilizing molecules. Examples of supramolecular complexes include initiators such as boron trifluoride complexes, complex aromatic salts of Lewis acids such as diaryl iodonium, triarylsulfonium, or arene diazonium, that form a clathrate compound with a crown ether. In particular embodiments, the curing agent may be a supramolecular complex involving a host-guest interaction between a cationic ammonium salt and a crown ether molecule in the presence of a tetrafluoroborate ion to form an ammonium tetrafluoroborate crown ether clathrate complex. The host-guest interaction between a cation and a crown ether may be explained through the formation of multiple hydrogen bonds between the cation and the negatively charged lone electron pairs located on the oxygen atoms of the crown ether. A stable complex may form when the Van der Waals diameter of the primary ammonium cation does not exceed a certain size which could lessen the strength of the hydrogen bonding interaction between the primary ammonium cation and the corresponding electronegative oxygens of the crown ether.

While the host-guest interaction between the cation and crown ether may produce a stable complex at room temperature and ambient pressure, the hydrogen bonding interaction can be destabilized by heating the complex, leading to dissociation into its components: the crown ether, the tetrafluoroborate anion, and the ammonium cation. Once dissociated, the tetrafluoroborate anion and primary ammonium cation establish an equilibrium with the superacid HBF₄ and the neutral amine. It then follows that latency can be induced in the reaction system until the point where the complex resulting from the host-guest interaction between the primary ammonium cation and a crown ether molecule is dissociated. Thus, in embodiments, the size of the ammonium cation may be varied to increase or decrease the stability of the supramolecular complex and, in effect, tune the reactivity of the complex as a curing agent.

Crown ethers in accordance with embodiments disclosed herein are cyclic structures capable of complexing cations that may include, but are not limited to, one or more of cyclic polyethers, 12-crown-4, 15-crown-5, 18-crown-6, benzo-18-crown-6, (2,4)dibenzo-18-crown-6, cyclohexano-18-crown-6, cis-dicyclohexano-18-crown-6, 4-carboxybenzyl-18-crown-6, nitrobenzo-18-crown-6, dinitrobenzo-18-crown-6, diaza-18-crown-6, heteroatom-containing cyclic polyethers such as diaza-18-crown-6, bis(methoxymethyl)diaza-18-crown-6, Kryptofix 222 (4,7,13,16,21,24-hexaoxa-1,10-diazabicyclo(8.8.8)-hexacosane), and the like. In particular embodiments, supramolecular complexes in accordance with the instant disclosure include complexes formed from an anilinium ion such as a 4-haloaniline, tetrafluoroborate (BF₄⁻), and 18-crown-6 ether.

Supramolecular complexes may be designed to release an initiator capable of polymerization when exposed to a triggering stimulus such as a change in temperature, pH, ionic strength, or in response to exposure to certain wavelengths of light. For example, in one or more embodiments, a supramolecular complex may be nonreactive at room temperature and pumped downhole with a polymerizable material in fluid contact. The elevated temperature downhole may then trigger the release of an active species that triggers polymerization of the polymerizable material. In some embodiments, the temperature range of activation may be varied depending on the choice of the ammonium cation and crown ether of a supramolecular complex. In particular embodiments, the initiator temperature of activation may be at least 30° C., at least 50° C., at least 70° C., or at least 90° C.

In one or more embodiments, the above described curing agents may be encapsulated by particles or polymers that release encapsulated curing agents upon exposure to an appropriate stimulus. Suitable encapsulants may be a polymer coating that is water soluble, water degradable, temperature degradable, oil soluble, or enzyme degradable, for example. In this way, a coated curing agent is passivated or in a dormant state at room temperature and the mixture of the polymerizable material and dormant curing agent can be easily pumped down hole. For example, an elevated temperature downhole and the presence of water may solubilize an encapsulant, triggering the release of an active curing agent that initiates the curing of the polymerizable material.

Advantages of the subject disclosure may include: (a) ease of reaching a zone that needs to be sealed, patched or repaired; (b) the crosslinkage (the solidification) of a polymerizable material can be actively triggered or passively triggered by changes occurring in the environment (e.g., change in temperature, contact with a curing agent, etc.); (c) both polymerizable material and curing agent may be homogenized; and (d) there is no loss of initiator during the crosslinking process. Consequently, the reaction is fast and efficient. The reaction time can also be tuned (faster or slower) depending on the circumstances of the operation and operating conditions.

While the disclosure includes a limited number of embodiments, those skilled in the art, having benefit of this disclosure, will appreciate that other embodiments may be devised which do not depart from the scope of the present disclosure. Accordingly, the scope should be limited only by the attached claims. Moreover, embodiments described herein may be practiced in the absence of any element that is not specifically disclosed herein.

Although only a few example embodiments have been described in detail above, those skilled in the art will readily appreciate that many modifications are possible in the example embodiments without materially departing from this disclosure. Accordingly, all such modifications are intended to be included within the scope of this disclosure as defined in the following claims. In the claims, means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures. It is the express intention of the applicant not to invoke 35 U.S.C. §112, paragraph 6 for any limitations of any of the claims herein, except for those in which the claim expressly uses the words ‘means for’ together with an associated function.

What is claimed:

1. A method comprising:
emplacing a polymerizable material within a wellbore, wherein the polymerizable material comprises a polymerizable component and a latent curing agent;
initiating polymerization of the polymerizable material; and
forming a seal within the wellbore.

2. The method of claim 1, wherein the polymerizable material is a latent polymerizable material and initiating polymerization of the latent polymerizable material by emplacement within a downhole region having a temperature that is elevated with respect to surface temperature.

3. The method of claim 1, wherein emplacing the polymerizable material further comprises injecting the polymerizable material into a packer present in the wellbore.

4. The method of claim 3, wherein the polymerizable material is present within the packer and wherein the method further comprises longitudinally compressing the packer using mechanical or hydraulic force to form the seal prior to initiating polymerization of the polymerizable material.

5. The method of claim 4, wherein the packer is compressed until the polymerizable material sets.

6. The method of claim 1, wherein forming the seal within the wellbore comprises the formation of a polymer foam from the polymerizable material.

7. A method comprising:
deploying an elastic membrane downhole;
expanding the elastic membrane downhole; and
initiating the polymerization of a polymerizable material within the membrane thereby forming a downhole seal.

8. The method of claim 7, wherein expanding the elastic membrane downhole comprises compressing the elastic membrane.

9. The method of claim 7, wherein the elastic membrane is configured to expand by at least 100% in size with respect to the initial dimensions of the elastic membrane.

10. The method according to claim 7, further comprising injecting a polymerizable material into the elastic membrane.

11. The method according to claim 7, further comprising injecting a curing agent into the elastic membrane while downhole.

12. The method according to claim 7, wherein the membrane contains a polymerizable material prior to deployment.

13. The method according to claim 7, wherein the membrane contains a latent curing agent prior to deployment.

14. The method according to claim 13, further comprising allowing the latent curing agent to reach a sufficient temperature to initiate curing of the polymerizable material.

15. A method comprising:
emplacing a section of pipe having a surrounding membrane into an interval of a wellbore, wherein the section of pipe contains one or more openings between the interior of the section of pipe and a region of the surrounding elastomeric membrane; and
injecting a polymerizable material through the section of pipe and into the surrounding membrane;
initiating polymerization of the polymerizable material; and
forming a seal within an interval of the wellbore.

16. The method of claim 15, wherein injecting the polymerizable material into the membrane surrounding the section of pipe causes the elastomeric membrane to expand.

17. The method of claim 15, wherein initiating the polymerization of the polymerizable material comprises allowing the polymerizable material to reach a sufficient temperature downhole.

18. The method of claim 15, wherein the membrane or the section of pipe contains a curing agent coated thereon.

19. A method comprising:
emplacing a lower sealing element within an interval of a wellbore below a target region;
emplacing a section of tubing or drill pipe near the target region;
emplacing an upper sealing element within an interval of the wellbore above the target region;
isolating the target region between the upper sealing element and the lower sealing element;
injecting a polymerizable material into the isolated target region;
initiating polymerization of the polymerizable material; and
forming a seal within the isolated target region.

20. The method of claim 19, wherein the section of tubing or drill pipe further comprises a tool that directs the polymerizable material into a region of damage within the target region.
